(19) United States
(12) Patent Application Publication
(10) Pub. No.: US 2007/0021127 A1
(43) Pub. Date: Jan. 25, 2007

(54) Method and apparatus for supporting location service over radio communication systems

(76) Inventor: Haihong Zheng, Coppell, TX (US)

Correspondence Address: DITTHAVONG & MORI, P.C., Suite A, 10507 Braddock Road, Fairfax, VA, 22032, US

(21) Appl. No.: 11/490,306

(22) Filed: Jul. 20, 2006

Related U.S. Application Data
(60) Provisional application No. 60/701,887, filed on Jul. 22, 2005.

(51) Int. Cl. H04Q 7/20

(52) U.S. Cl. 455/456.1

(57) ABSTRACT

An approach is provided for reliably exchanging location service data over an unlicensed mobile access network operating with a cellular network. A request is processed for position location information of a terminal configured to operate with an unlicensed mobile access network that has connectivity with a radio communication network for providing a position location service. Data message specifying the position location information is generated, wherein the data message and the request are generated according to a signaling protocol that is compatible with the unlicensed mobile access network. Reliable delivery of the data message is provided by a transport layer protocol.

### RELATED APPLICATIONS

This application claims the benefit of the earlier filing date under 35 U.S.C. §119(e) of U.S. Provisional Application Ser. No. 60/701,887 filed Jul. 22, 2005, entitled “Method and Apparatus for Supporting Location Service Within an Unlicensed Mobile Access Network and a Cellular System,” the entirety of which is incorporated by reference.

### FIELD OF THE INVENTION

Embodiments of the invention relate to communications, and more particularly, to supporting a position location service over radio communication systems.

### BACKGROUND

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features.

Concurrent with the rapid development in cellular technologies, unlicensed wireless technologies enjoy ever increasing deployment to provide users with greater functionality, flexibility, and cost-effectiveness. One area of effort involves extending mobile services to unlicensed spectrums to provide users with seamless delivery of mobile voice and data services. Because cellular technology and unlicensed wireless technology employ different protocols and standards, many inefficiencies in terms of signaling, reliability and spectrum use exist, particularly in the areas of location service and emergency service.

Therefore, there is a need for an approach to provide spectrally efficient location service and emergency service between an unlicensed mobile access network and a cellular network, without modification of existing standards and protocols.

### SOME EXEMPLARY EMBODIMENTS

These and other needs are addressed by the embodiments of the invention, in which an approach is presented for reliably exchanging location service data over an unlicensed mobile access network operating with a cellular network.

According to one aspect of an embodiment of the invention, a method comprises processing a request for position location information of a terminal configured to operate with an unlicensed mobile access network that has connectivity with a radio communication network for providing a position location service. The method also comprises generating a data message specifying the position location information, wherein the data message and the request are generated according to a signaling protocol that is compatible with the unlicensed mobile access network. Reliable delivery of the data message is provided by a transport layer protocol.

According to another aspect of an embodiment of the invention, an apparatus comprises a processor configured to process a request for position location. The processor is further configured to generate a data message specifying the position location information for transmission over an unlicensed mobile access network that has connectivity with a radio communication network for providing a position location service. The data message and the request are generated according to a signaling protocol that is compatible with the unlicensed mobile access network. Reliable delivery of the data message is provided by a transport layer protocol.

According to another aspect of an embodiment of the invention, a method comprises receiving a message to initiate a position location service. The message has a format according to a signaling protocol compatible with an unlicensed mobile access network, wherein the unlicensed mobile access network has connectivity with a radio communication network for providing the position location service. The method also comprises generating a service request, in response to the received message, for transmission to the radio communication network; and receiving an assignment request from the radio communication network for allocation of network resource within the unlicensed mobile access network. Further, the method includes generating a data message specifying position location information of a terminal, wherein the data message is generated according to the signaling protocol, and reliable delivery of the data message being provided by a transport layer protocol.

According to another aspect of an embodiment of the invention, an apparatus comprises a processor configured to receive a message to initiate a position location service. The message has a format according to a signaling protocol compatible with an unlicensed mobile access network, wherein the unlicensed mobile access network has connectivity with a radio communication network for providing a position location service. The processor is further configured to generate a service request, in response to the received message, for transmission to the radio communication network, and to receive an assignment request from the radio communication network for allocation of network resource within the unlicensed mobile access network. The processor is further configured to generate a data message specifying position location information of a terminal. The data message is generated according to the signaling protocol. Reliable delivery of the data message is provided by a transport layer protocol.

According to another aspect of an embodiment of the invention, a method comprises receiving an origination message according to unlicensed mobile access (UMA) layer 3 protocol to initiate a position location service supported by an unlicensed mobile access network and a cellular communication network. The method also comprises determining whether the origination message specifies an emergency call; and establishing an audio path to the terminal only if the origination message specifies the emergency call. Further, the method comprises generating a data message specifying the position location information for transmission to a terminal without utilizing an unlicensed mobile access (UMA) layer 2 protocol to acknowledge receipt of the data message, wherein the data message is generated according to the UMA layer 3 protocol.

According to yet another aspect of an embodiment of the invention, a method comprises receiving a paging request from a mobile switching center of a cellular network. The paging request initiates a position location service supported by the cellular network and an unlicensed mobile access network. The method also comprises generating a data message to obtain position location information of a terminal for transmission to a terminal according to an unlicensed mobile access (UMA) layer 3 protocol, wherein reliable delivery of the data message is provided by a transport layer protocol distinct from a UMA layer 2 protocol.

Still other aspects, features, and advantages of the embodiments of the invention are readily apparent from the following detailed description, simply by illustrating a number of particular embodiments and implementations, including the best mode contemplated for carrying out the embodiments of the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIG. 1 is a diagram of a communication system for extending mobile services over unlicensed spectrum, in accordance with various embodiments of the invention;

FIG. 2 is a diagram of an unlicensed mobile access (UMA) functional architecture, in accordance with various embodiments of the invention;

FIG. 3 is a diagram of a Up protocol architecture supporting circuit switched domain signaling, in accordance with various embodiments of the invention;

FIG. 4 is a diagram of a Up voice bearer protocol architecture supporting circuit switched domain signaling, in accordance with various embodiments of the invention;

FIG. 5 is a diagram of a call flow for supporting a mobile originated position location service on a traffic channel in a code division multiple access (CDMA) network;

FIG. 6 is a diagram of a call flow for supporting a mobile originated call setup in an unlicensed mobile access-code division multiple access (UMA-cdma) network, in accordance with various embodiments of the invention;

FIG. 7 is a flowchart of a process for providing location service, in accordance with an embodiment of the invention;

FIG. 8 is a diagram of a call flow for supporting a mobile station (MS) originated position location service in a UMA-network, in accordance with various embodiments of the invention;

FIG. 9 is a diagram of a call flow for supporting a mobile station terminated position location service in a UMA-network, in accordance with various embodiments of the invention;

FIG. 10 is a diagram of hardware that can be used to implement an embodiment of the invention;

FIGS. 11A and 11B are diagrams of different cellular mobile phone systems capable of supporting various embodiments of the invention; and

FIG. 12 is a diagram of exemplary components of a mobile station capable of operating in the systems of FIGS. 11A and 11B, according to an embodiment of the invention.

FIG. 13 is a diagram of an enterprise network capable of supporting the processes described herein, according to an embodiment of the invention.

### DESCRIPTION OF THE PREFERRED EMBODIMENT

An apparatus, method, and software for providing position location service over an unlicensed wireless network and a cellular system are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to spread spectrum systems and unlicensed mobile access (UMA) networks, it is recognized by one of ordinary skill in the art that the embodiments of the inventions have applicability to any type of radio communication systems. Also, various embodiments of the invention are described with respect to the Transmission Control Protocol (TCP) and Real Time Protocol (RTP); however, it is contemplated that other equivalent communication protocols can be used in practicing the various embodiments of the invention.

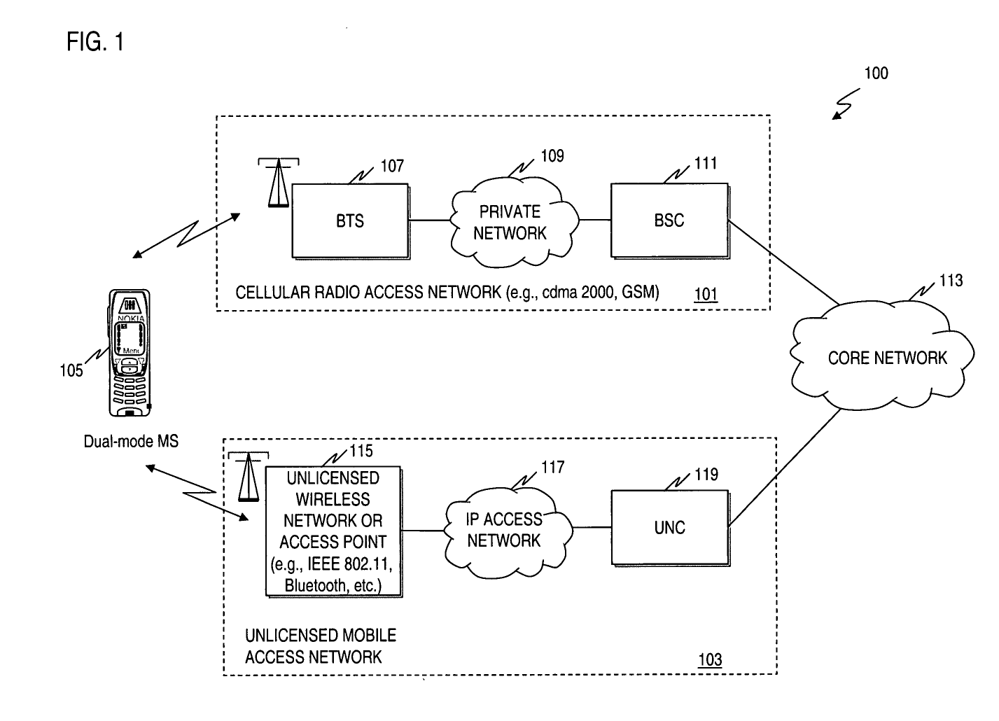

FIG. 1 is a diagram of a communication system for extending mobile services over unlicensed spectrum, in accordance with various embodiments of the invention. A communication system 100 includes a cellular radio access network 101 and an unlicensed mobile access network 103. The unlicensed mobile access network 103 is a complement to the radio coverage of the cellular radio access network 101; for example, the access network 103 can be used to enhance customer premises coverage, increasing network capacity with potentially lower cost. The system 100 supports a position location service in a manner that attempts to optimize spectral use and protocol efficiency, as will be more fully explained later. The position location service provides for the transfer of position location information or data between an application residing on a station 105 and an application within the network (i.e., Position Determination Entity (PDE)). Position location information of the station 105, for instance, is vital in an emergency call, in which geographic location of the user is necessary to provide assistance.

In an exemplary embodiment, the station 105 has dual-mode capability to communicate directly with either the cellular radio access network 101 or the unlicensed mobile access network 103. The station 105, in one embodiment, can be a mobile. As used herein, the terms “mobile,” “mobile station (MS),” “mobile device” or “unit” are synonymous. Although the various embodiments of the invention describe the mobile as a handset, it is contemplated that any mobile device with voice functionality can be used (e.g., a combined Personal Digital Assistant (PDA) and cellular phone). The MS 105 is a device that provides data connectivity as well as telephony services to a user. For example, the MS 105 can be connected to a computing system, such as a personal computer, a personal digital assistant, and etc. or a data service enabled cellular handset.

As shown, the cellular radio access network 101 includes a base transceiver station (BTS) 107 with connectivity over a private network 109 to a base station controller (BSC) 111. The BSC 111 communicates with the unlicensed mobile access network 103 through a core network 113.

The MS 105 can also communicate with the core network 113 via the unlicensed mobile access network 103. The unlicensed mobile access network 103 includes an unlicensed wireless network 115 (or access point (AP)), which communicates using an IP access network 117 with an Unlicensed Mobile Access (UMA) Network Controller (UNC) 119.

The UNC 119 communicates with the core network 113 which may include home and visited networks. It is recognized that although UMA for CDMA 2000 has not been discussed in the 3GPP2 standard forum, it is expected that the same UMA architecture defined for GSM (Global System for Mobile Communications)/GPRS (General Packet Radio Service) will be used. UMA for GSM/GPRS is more fully described in the “UMA Architecture (Stage 2),” Oct. 2004, which is incorporated herein by reference in its entirety.

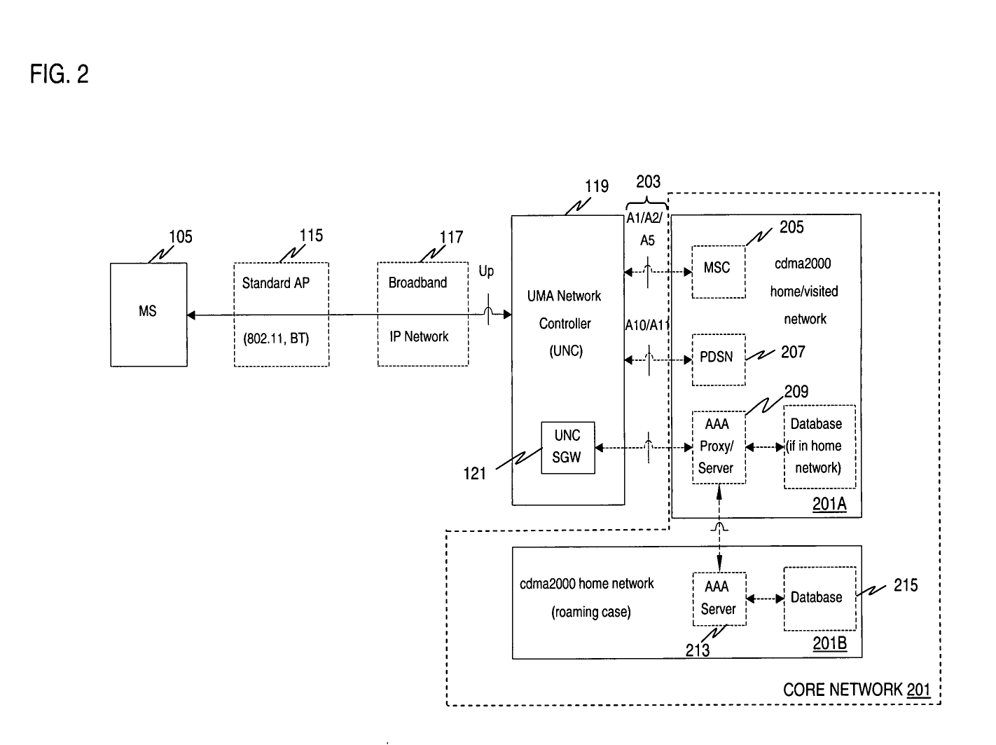

In an exemplary embodiment, the unlicensed mobile access network 103 employs an UMA (Unlicensed Mobile Access) architecture, which interfaces with the cellular radio access network 101—e.g., a spread spectrum system (e.g., Code Division Multiple Access 2000). According to one embodiment of the invention, the system 100 possesses a UMA-cdma2000 architecture, which is more fully described with respect to FIGS. 2-4. UMA for cdma2000 is an extension of CDMA 2000 mobile services (i.e., all types of services that are supported by the current A1/A2/A5 and A10/A11 interfaces) to the customer's premises by tunnelling certain CDMA 2000 protocols between a customer's premises and the core network 113 over a broadband Internet Protocol (IP) network 117, and relaying them through an unlicensed radio link (e.g., WiFi™ (Wireless Fidelity), Bluetooth™, IEEE (Institute of Electrical and Electronics Engineers) 802.11). The network 115 can be operated within or around a customer's premise.

FIG. 2 is a diagram of an unlicensed mobile access (UMA) functional architecture, in accordance with various embodiments of the invention. In this example, the architecture for CDMA 2000 is shown. The architecture includes one or more standard access points 115 and one or more UMA Network Controllers (UNCs) 119, interconnected through the broadband data network 117 (e.g., Internet Protocol (IP) based network). The UNC 119 includes a UNC Secure Gateway (SGW) 121.

The UNC 119 connects, for example, to a CDMA 2000 core network 201 through standard CDMA 2000 interfaces 203. In this example, the cdma home/visited network 201A includes a Mobile Switching Center (MSC) 205, a Packet Data Serving Node (PDSN) 207, and an authentication, authorization and accounting (AAA) proxy server 209, which may access a database 211 within a home network to authenticate the MS 105. As shown, the UNC 119 communicates with the mobile switching center 205 of the home/visited network 201 via A1/A2/A5 interfaces. Among other functions, the MSC 205 is capable of routing calls to and from the MS 105. In the roaming case, the cdma2000 home network 201B provides for an AAA server 213 that communicates with the AAA proxy server 209. The AAA server 213 has access to the database 215 of the cdma2000 home network 201B.

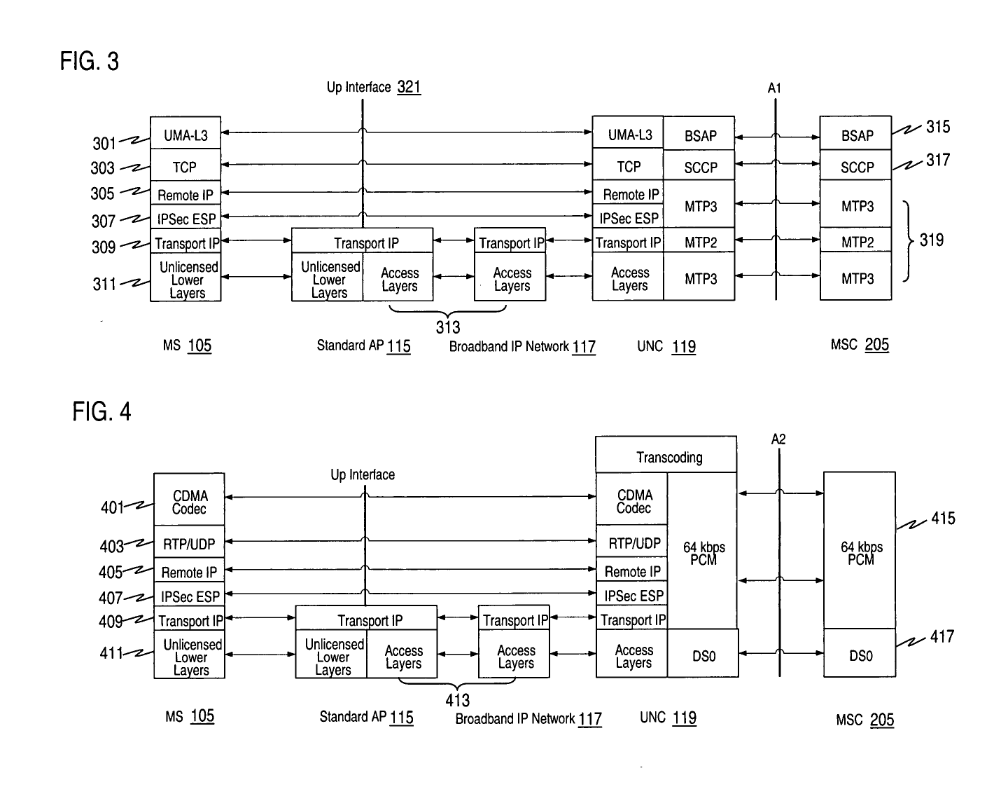

FIG. 3 is a diagram of a Up protocol architecture supporting circuit switched (CS) domain signaling, in accordance with various embodiments of the invention. At the MS 105, the protocol stack includes an UMA-L3 protocol 301 (also denoted as UL3), which supports the UMA Layer-3 signaling functions. UMA-L3 301 replaces the cdma L3, and provides additional UMA specific functions. UMA-L3 301 exploits the characteristics of the unlicensed radio link; these characteristics can be quite different from the cdma radio link. For example, UMA-L3 301 provides the following functions: registration with UNC 119; setup of bearer path for both circuit-switched traffic and packet switched traffic between the MS 105 and UNC 119; handoff support between the cdma radio access network 101 and the unlicensed mobile access network 103; support of identification of the AP 115 being used for UMA access; support of other functions such as paging, ciphering configuration, etc.; and transparent transfer of the cdma L3 messages that are not radio resource management related between the MS 105 and UNC 119.

The next lower layer is a transport layer protocol 303, such as the Transmission Control Protocol (TCP). The protocol stack also provides a Remote IP layer 3 05, an IPSec ESP (Internet Security Encapsulated Security Payload) 307, a Transport IP 309 and Unlicensed Lower Layers 311.

To communicate with the MS 105, the access point 115 utilizes a transport IP 309 and the unlicensed lower layers 311. On the network side of the Up interface 321, the access point 115 utilizes access layers 313. As shown, the broadband IP network 117 employs the transport IP 309 and the access layers 313.

The UNC 119 implements the same protocol stack as the MS 105. However, for communication over the Al interface, the UNC 119 provides the following protocols: Base Station Application Part (BSAP) 315, Signaling Connection Control Part (SCCP) 317, and Message Transfer Part (MTP) 319, such as MTP3, MTP2 and MTP3. This stack is provided at the MSC 205.

It is noted that UMA-cdma need not be identical to UMA for GSM/GPRS (General Packet Radio Service). The difference lies largely in the use of UL3 301 for UMA-cdma and URR (UMA Radio Resource) for UMA-GSM/GPRS. Also, unlike GSM, cdma2000 does not differentiate MM (Mobility Management), CC (Call Control) and SS (Supplementary Services) functions at L3. In addition, all the L3 messages in cdma2000 are not carried transparently between the MS 105 and MSC 205, but terminated at BSS (Base Station Subsystem) (not shown). Therefore, UNC 119, acting as BSS, interworks these protocols to the A1 interface between UNC 119 and MSC 205 using BSAP messaging. This allows the MS 105 to obtain all the cdma2000 services through a UMA network in the same way as if the MS 105 is attached to a cdma2000 BSS. Further, dissimilar to UMA-GSM, the UMA-L3 layer 301 is introduced to support cdma L3 functions as well as other UMA specific functions.

Two considerations of the UMA-L3 protocol 301 are of particular note. First, the non-radio resource management related cdma L3 signaling message (such as Mobile registration to the cdma network, terminal authentication, SSD (Shared Secret Data) update) can be transparently transferred between the MS 105 and the UNC 119 inside a UL3 tunneling message —e.g., UL3 Uplink/Downlink Direct Transfer, which is similar to URR UPLINK/DOWNLINK DIRECT TRANSFER defined for UMA-GSM. Second, the radio resource management related cdma L3 signaling message (such as Origination message, Channel Assignment message, Service Connect message, Service Completion message) can be replaced by new UL3 messages. For example, such UL3 message could be designed based on UMA-GSM/GPRS URR message with modification at the parameter level (e.g., the Channel Assignment Message can be replaced by the UL3 Activate Channel message that is similar to URR ACTIVATE CHANNEL message with modification at the parameter level). Alternatively, the UL3 message can be designed particularly for UMA-cdma; e.g., the Origination Message is replaced by a UL3 Origination message.

By way of example, the UMA-L3 301 messages are transferred over the Up interface 321 in the following ways. If the corresponding cdma L3 message is not related to radio resource management, it is transparently transferred between the MS 105 and the UNC 119 within, for instance, a UL3 Uplink/Downlink Direct Transfer message. Also, if the corresponding cdma L3 message is related to radio resource management, it can be replaced by a UL3 message. This UL3 message can be in the following formats: (1) reuse the URR (UMA Radio Resource) message defined for GSM/GPRS case without any modification; (2) reuse the URR message defined for GSM/GPRS case with modification at the parameter level; or (3) a new UL3 message defined expressly for UMA-cdma.

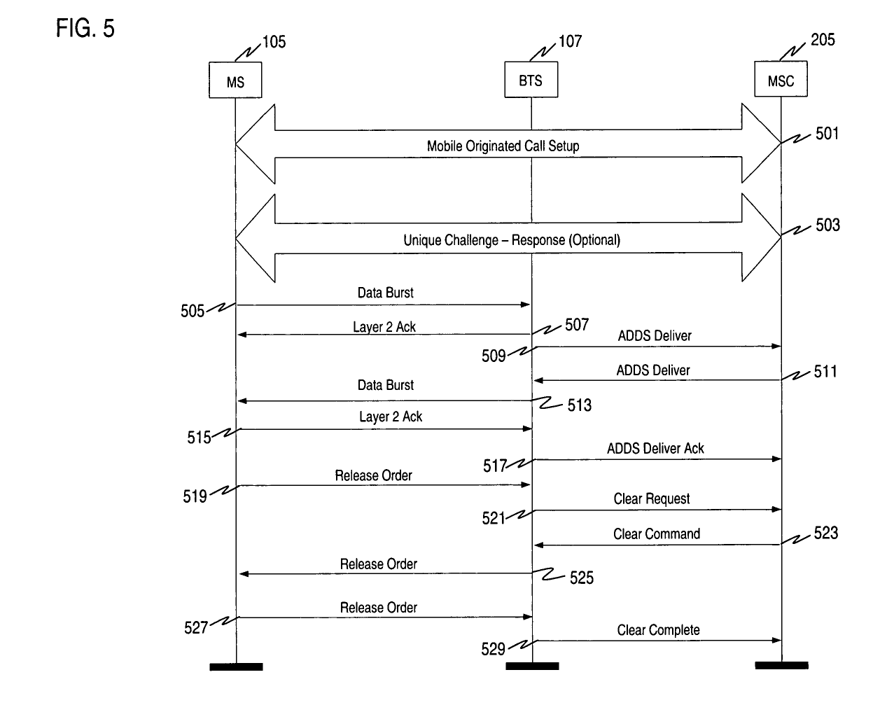

FIG. 4 is a diagram of a Up voice bearer protocol architecture supporting circuit switched (CS) domain signaling, in accordance with various embodiments of the invention. Under this architecture, a bearer channel (or audio path) can be established between the MS 105 and the UNC 119. To accomplish this, in an exemplary embodiment, the MS 105 is provided with the following protocols: a CDMA codec layer 401, RTP/UDP (Real Time Protocol/User Datagram Protocol) 403, a Remote IP layer 405, an IPSec ESP (Internet Security Encapsulated Security Payload) 407, a Transport IP 409 and Unlicensed Lower Layers 411.

The protocols utilized at the access point 115 and the broadband IP network 117 are similar to the architecture of FIG. 3. That is, the access point 115 utilizes a transport IP 309 and the unlicensed lower layers 411 to interface the MS 105. To communicate with the IP network 117, the access point 115 utilizes a transport IP layer 409 and the access layers 413.

At the UNC 119, in addition to the protocol stack employed by the MS 105, the UNC 119 utilizes a transcoding layer. Further, the UNC 119 includes a pulse code modulation layer 415 and a digital signaling layer 417 (which in this example, is Digital Signal Level 0 (DS0)); these functions are also resident within the MSC 205.

For example, the UNC 119 can establish a RTP/UDP stream to setup a bearer channel with the MS 105 be exchanging bearer path setup information. This information can include channel coding, UDP port and IP address for the uplink stream, the voice sample size, etc. In particular, the MS 105 establishes a real time protocol (RTP) path to the UNC 119—i.e., uplink RTP path. Also, the MS 105 can send a channel acknowledge message to the UNC 119 indicating the UDP port 403 and IP address for the downlink stream. The UNC 119 then establishes the downlink RTP path with the MS 105 such that the UNC 119 may begin transmitting RTP/UDP packets to the MS 105. An end-to-end audio path can thus be setup between the MS 105 and the core network 113.

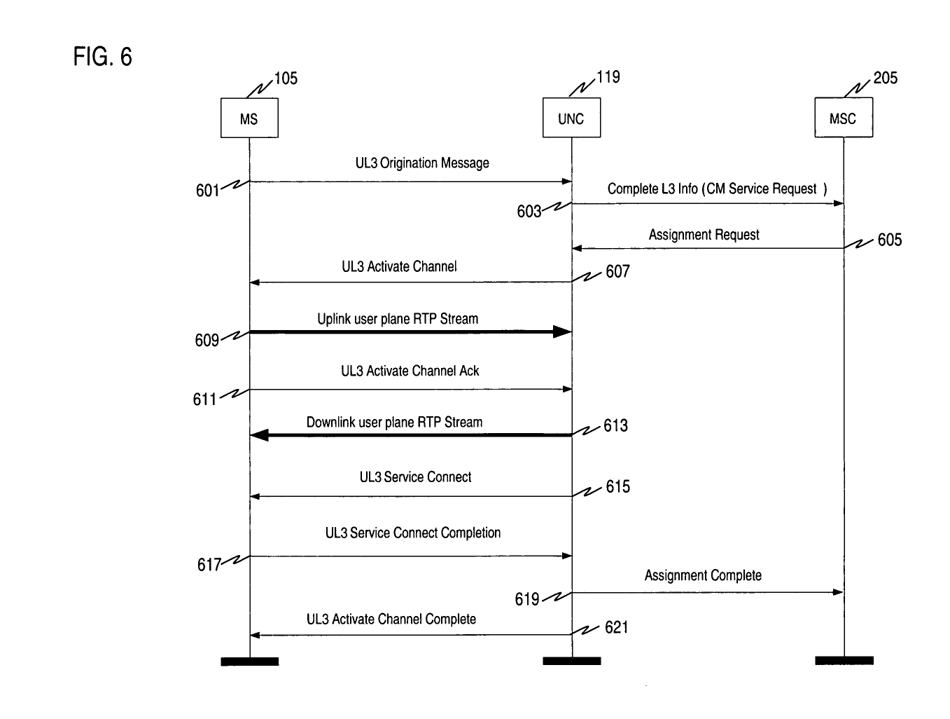

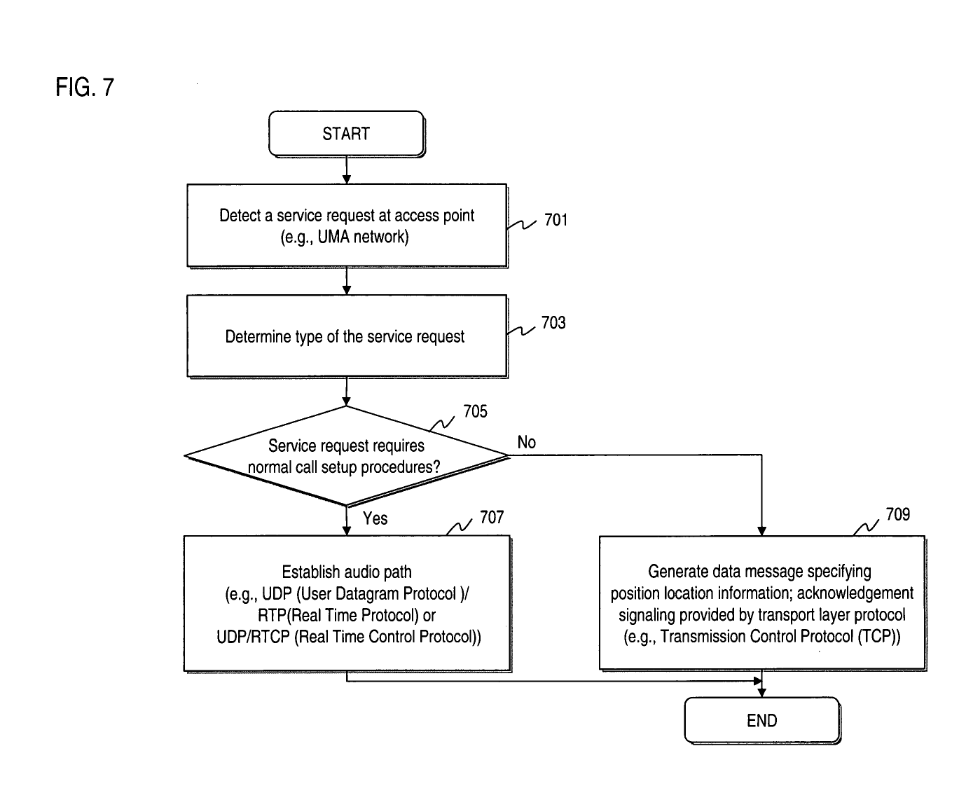

The architectures explained above support the capability to efficiently provide position location service across the unlicensed mobile access network 103 and the cellular radio access network 101. To better appreciate this capability, it is instructive to examine the processes of FIGS. 5 and 6 for providing position location service.

FIG. 5 is a diagram of a call flow for supporting a mobile originated position location service on a traffic channel in a CDMA network. Typically, normal call setup procedures for voice calls are used to establish a position location service call within a CDMA network. In step 501, the MS 105 originates a position location service call. Optionally, the MSC 205 may initiate a unique challenge request-response, per step 503. In step 505, the MS 105 sends the position location information within a data burst to the BTS 107 on the traffic channel. The BTS 107 acknowledges receipt of the data burst using a Layer 2 protocol to issue an Acknowledgement (Ack) message.

The BTS 107, in step 509, encapsulates the position location information in an ADDS(Application Data Delivery Service) Deliver message and sends it to the MSC 205. If the PDE (not shown) has information for the MS 105, the MSC 205 sends the information in an ADDS Deliver message to the BTS 107 (step 511); this message specifies a Tag information element.

In step 513, the BTS 107 sends a data burst message to the MS 105 over the traffic channel and indicates that a Layer 2 Ack is required. Upon receipt of the data burst, in step 515, the MS 105 sends a Layer 2 Ack to the BTS 107. Thereafter, in step 517, the BTS 107 sends an ADDS Deliver Ack to the MSC 205, including the Tag information element it received in the ADDS Deliver message.

In step 519, the MS 105 decides to terminate the position location service and sends a Release Order to clear the call. The BTS 107 sends a Clear Request message, as in step 521, to the MSC 205 and starts a timer. In step 523, the MSC 205 sends a Clear Command message to the BTS 107 to instruct the BTS 107 to release the traffic channel, and starts another timer. Upon receipt of this message, the BTS 107 stops the first timer. Next, the BTS 107 initiates call clearing over the air interface by transmitting a Release Order over the forward traffic channel (step 525).

Accordingly, the MS 105 responds by sending a Release Order to the BTS 107 (in step 527) and releasing the traffic channel. In step 529, the BTS 107 sends a Clear Complete message to the MSC 205. Upon receipt of this message, the MSC 205 stops its timer (started in step 523). This flow is further detailed 3GPP2A.S0013-B, entitled “Interoperability Specification (IOS) for cdma2000 Access Network Interfaces (3G-IOS-v4.3.1),” which is incorporated herein by reference in its entirety

FIG. 6 is a diagram of a call flow for supporting a mobile originated call setup in an Unlicensed Mobile Access-Code Division Multiple Access (UMA-cdma) network, in accordance with various embodiments of the invention. In contrast to the cdma network, when UMA is used instead to provide position location service in the UMA-cdma network, the mobile originated call setup procedure of FIG. 5 can be directly applied. However, the reliability and spectrum efficiency is not optimized, as explained below.

Under this scenario, the MS 105 sends a UL3 (UMA Layer 3) Origination Message to the serving UNC 119, per step 601. The serving UNC 119 then establishes a Signaling Connection Control Part (SCCP) connection to the MSC 205, and constructs a Connection Management (CM) Service Request Message, places it in the Complete Layer 3 Information message for transmission to the MSC 205, as in step 603. In step 605, the MSC 205 sends an Assignment Request message to the UNC 119 to request assignment of call resources.

Next, the serving UNC 119 sends a UL3 Activate Channel message, per step 607, to the MS 105. The message includes bearer path setup information, such as: the IP (Internet Protocol) address and UDP ports (RTP and RTCP (Real Time Control Protocol)) for the uplink stream; and RTP payload type (for dynamically assigned payload type). The MS 105 now establishes the RTP (Real Time Protocol) path to the UNC 119, as in step 609. It is noted that the MS 105 has not connected the calling party to the audio path.

In step 611, the MS 105 sends the UL3 (UMA Layer 3) Activate Channel Ack (Acknowledgement) to the UNC 119 indicating the IP (Internet Protocol) address and the UDP ports (RTP/RTCP) for the downlink stream. The UNC 119 establishes the downlink RTP (Real Time Protocol) path between itself and the MS 105, as in step 613. In step 615, the UNC 119 sends the UL3 Service Connect Message to the MS 105 specifying the service configuration for the call. The MS 105 begins processing traffic in accordance with the specified service configuration. The MS 105 responds with a UL3 Service Connect Completion Message to the UNC 119 in step 617.

After the radio resource and the circuit have both been established and fully interconnected, as in step 619, the UNC 119 then sends an Assignment Complete message to the MSC 205, and considers the call to be in conversation state. The UNC 119 signals the completion of the bearer path to the MS 105 with the UL3 Activate Channel Complete message in step 621. The MS 105 can now connect the calling party to the audio path.

As described previously, to provide position location service in a UMA-cdma network, the mobile originated call setup procedure in UMA-cdma is used to initiate a position location service call. It is recognized that with such approach, two issues are of concern. First, after the call setup procedure is complete, one UDP/RTP based and one UDP/RTCP based traffic channels are established between MS 105 and UNC 119 to transport the data for location services. However, if the location service is not invoked for the purposes of supporting a voice call (e.g., emergency service), there is no need to have UDP/RTP based protocol to carry the data for location service. In addition, the established UDP/RTCP channel is not utilized, thereby resulting in wasted capacity.

Second, most location service data carried in a data burst message requires a Layer 2 Ack (Acknowledgement) in CDMA network. The same requirement applies to UMA-cdma network as well. When UDP/RTP based voice channel is used to carry the data burst message, little or no reliability (i.e., Ack based mechanism) can be provided by the UDP/RTP, and thus a different reliability mechanism is required.

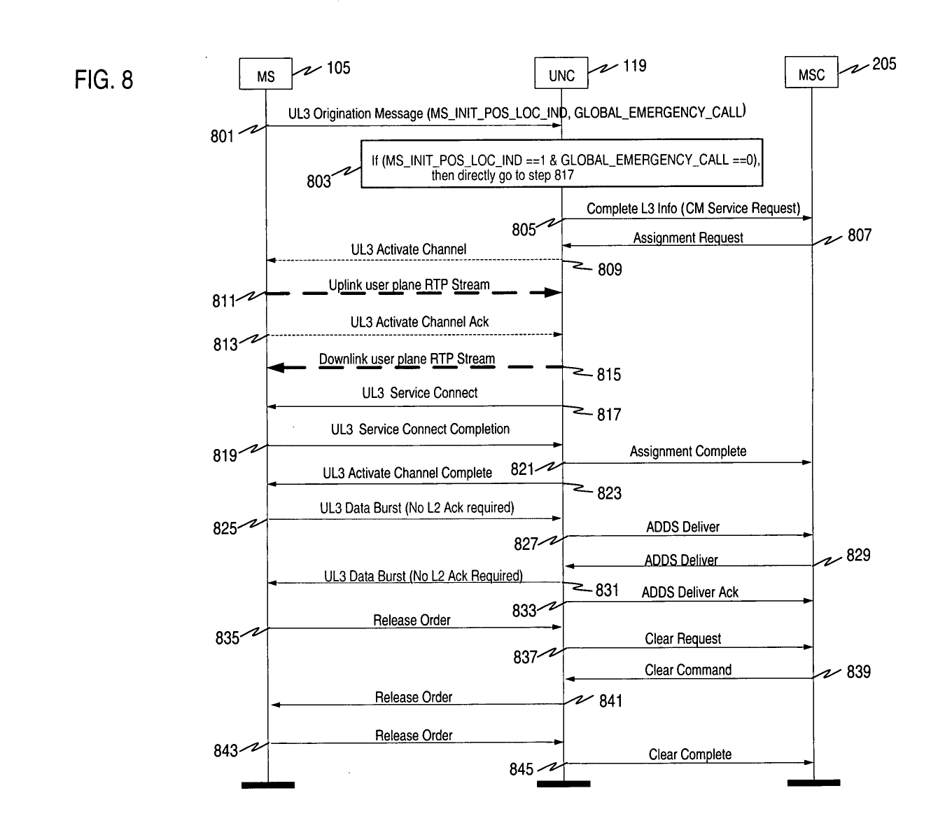

The position location service approach of the system 100, according to various embodiments of the invention, addresses the above concerns, as explained with respect to FIG. 7.

FIG. 7 is a flowchart of a process for providing location service, in accordance with an embodiment of the invention. In one aspect of the invention, the approach reuses, for example, the TCP/IP based transport layers for UL3 to provide reliable transfer of the location service data by transporting the data burst message in UL3. Such features can be applied to both MS 105 originated and network originated location service calls. In addition, for the MS originated call, if the requested location service is not related to an emergency call, the UNC 119 need not set up the UDP/RTP based voice traffic channel as in traditional call setup procedure. For the MS 105 terminated call, the UNC 119 need not establish the UDP/RTP based voice traffic channel as in traditional call setup procedure. This process is detailed below.

In step 701, a request for initiating a position location service supported by an UMA-cdma network is transmitted by the MS 105. Next, the process determines the type of the service request, as in step 703; e.g., whether the request is associated with a voice call. If the service request requires normal call set up procedures (step 705), a media path (e.g., audio path) is established, as in step 707. For instance, an UDP/RTP channel or an UDP/RTCP channel is setup between the MS 105 and the unlicensed wireless network 117. However, if the service request is not for the purpose of voice call (e.g., emergency service), a data message specifying the position information is generated, as in step 709. To optimize spectrum efficiency, the reliable delivery of the data message is governed by a transport layer protocol, such as TCP, instead of the UMA L2, which is characteristic of traditional approaches.

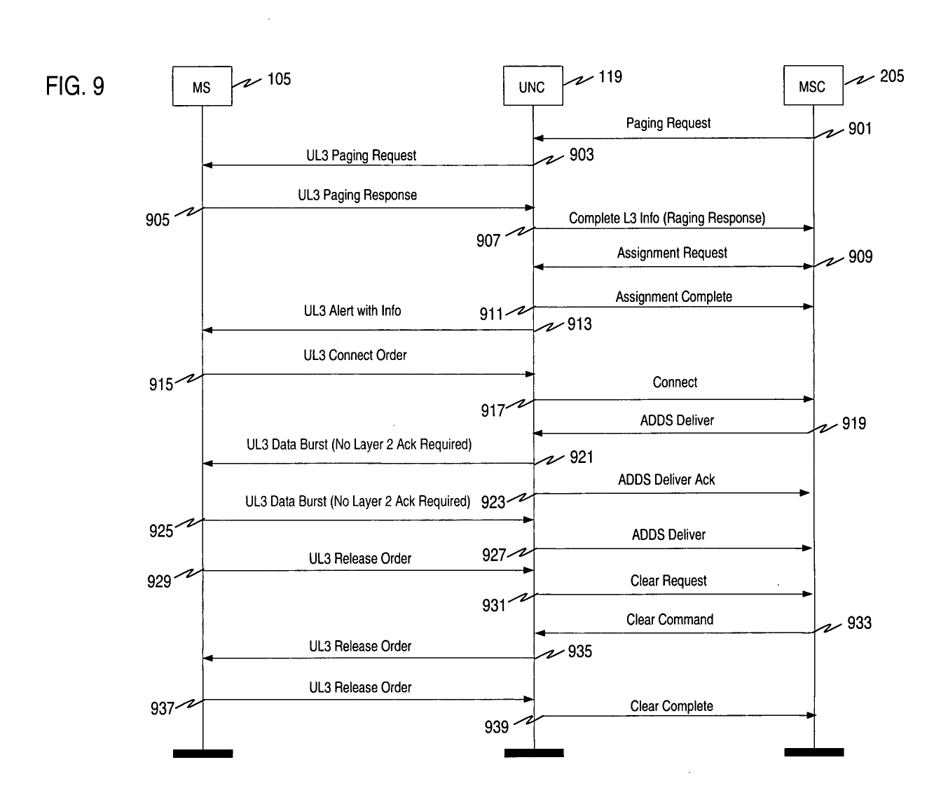

FIG. 8 is a diagram of a call flow for supporting a MS 105 originated position location service in a UMA (Unlicensed Mobile Access)-network, in accordance with various embodiments of the invention. As shown, in step 801, the MS 105 sends a UL3 Origination Message to initiate the position location service. The UL3 Origination Message, in this scenario, specifies the following fields: a position location service initiation bit (MS_INIT_POS_IND), and a global emergency call bit (GLOBAL_EMERGENCY_CALL). In step 803, these fields are checked by the UNC 119; if the position location service initiation bit is set to 1 and the global emergency call bit is set to 0 (indicating that the service request is not associated with an emergency voice call), then the process skips steps 805-815, and proceeds to step 817 directly.

In step 805, the UNC 119 sends a Complete L3 Information message, which indicates a CM service request, to the MSC 205. In response, the MSC 205 replies with an Assignment Request message, per step 807. In turn, the UNC 119 forwards a UL3 Activate Channel message to the MS 105 to instruct the MS 105 to commence establishment of an audio path. Accordingly, in step 811, the MS 105 sets up an uplink user plane RTP stream, and sends a UL3 Activate Channel acknowledgement message, as in step 813.

Thereafter, in step 815, the UNC 119 establishes a downlink user plane RTP stream. Per step 817, the UNC 119 sends a UL3 Service Connect message to the MS 105. In response to the received UL3 Service Connect message, the MS 105 forwards a UL3 Service Connect Completion message (step 819) to the UNC 119.

Next, the UNC 119 issues an Assignment Complete message to the MSC 205, as in step 821. In step 823, the UNC 119 sends a UL3 Active Channel Complete message to the MS 105, which responds with a UL3 data burst (step 825); this data burst includes the position location information. In contrast to the approach of FIG. 5, the UL3 data burst need not be acknowledged using acknowledgement signaling provided by the UMA layer 2 protocol, rather the reliable delivery mechanism involves use of higher layer protocol, such as TCP.

In step 827, the UNC 119 sends an ADDS Deliver message to the MSC 205, which accordingly responds, per step 829. The UNC 119 forwards a UL3 data burst, as in step 831, to the MS 105; similar to step 825, the data burst need not be acknowledged using the UMA layer 2 protocol.

The MS 105, in step 835, sends a Release Order message to the UNC 119, which then issues a Clear Request message to the MSC 205, per step 837. The MSC 205 then responds with a Clear Command message (step 839). In step 841, the UNC 119 transmits a Release Order message to the MS 105. In step 843, the MS 105 replies with its own Release Order message. Subsequently, the UNC 119 transmits a Clear Complete message to the MSC 205.

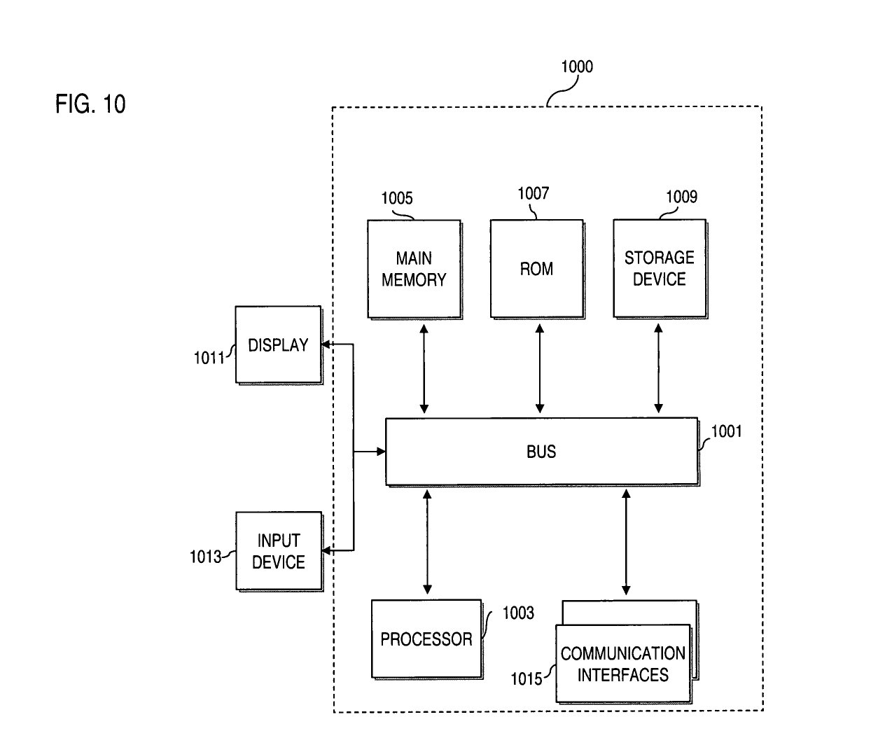

FIG. 9 is a diagram of a call flow for supporting a MS 105 terminated position location service in a UMA (Unlicensed Mobile Access)-network, in accordance with various embodiments of the invention. Under this exemplary scenario, the MSC 205 transmits a Paging Request message, per step 901, to initiate the position location service. In step 903, the UNC 119 generates a UL3 Paging Request message and sends the message to the MS 105. In step 905, the MS 105 replies with a UL3 Paging Response message. Next, the UNC 119 transmits a Complete L3 Information message, which specifies a Raging Response (step 907). The MSC 205 responds by issuing an Assignment Request message, per step 909. Accordingly, the UNC 119 submits an Assignment Complete message, per step 911. The UNC 119 also sends a UL3 Alert with Information message, as in step 913, to the MS 105. In step 915, the MS 105 sends a UL3 Connect Order message to the UNC 119. The UNC 119 thereafter transmits a Connect message to the MSC 205, as in step 917.

In step 919, the MSC 205 forwards an ADDS Deliver message to the UNC 119. At this point, the UNC 119 transmits, as in step 921, a UL3 data burst (in which no layer 2 acknowledgement is required). The UNC 119 sends an ADDS Deliver Acknowledgement message to the MSC 205 (step 923). The MS 105 likewise sends a UL3 data burst, as in step 925.

The UNC 119 issues, in step 927, an ADDS Deliver message to the MSC 205. In step 931, the MS 105 sends a UL3 Release Order message to the UNC 119, which then transmits a Clear Request message to the MSC 205 (step 933). The MSC 205 in turn forwards a Clear Command message to the UNC 119, as in step 935. In steps 937 and 939, the UNC 119 and the MS 105 exchange UL3 Release Order messages.

The described processes of FIGS. 8 and 9 advantageously utilize only processing logic in MS 105 and UNC 119, without modification to current standard protocols. In one embodiment, these processes provide for reuse of a transport layer mechanism, such as TCP, to provide reliable transfer of the location service data. In addition, the above arrangements eliminate the need to always setup audio paths, thereby achieving better spectrum efficiency.

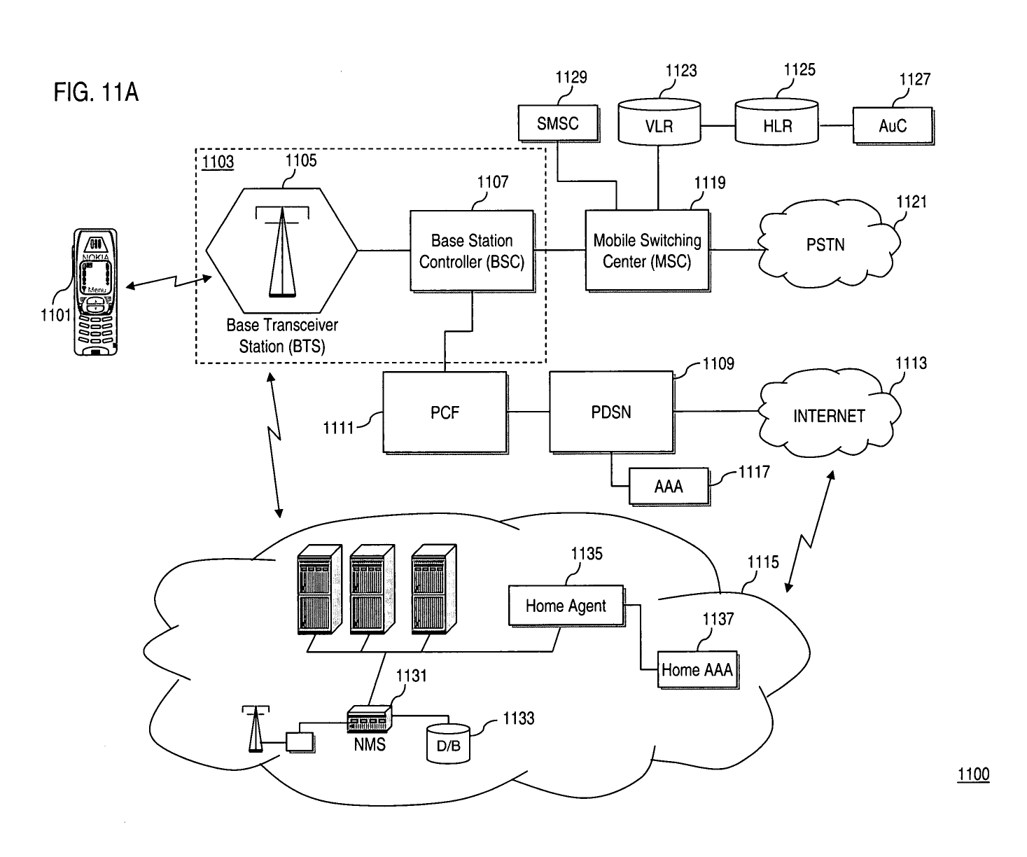

One of ordinary skill in the art would recognize that the processes for providing position location services supported by an unlicensed mobile access network and a cellular system may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 10.

FIG. 10 illustrates exemplary hardware upon which various embodiments of the invention can be implemented. A computing system 1000 includes a bus 1001 or other communication mechanism for communicating information and a processor 1003 coupled to the bus 1001 for processing information. The computing system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computing system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computing system 1000 may be coupled via the bus 1001 to a display 1011, such as a liquid crystal display, or active matrix display, for displaying information to a user. An input device 1013, such as a keyboard including alphanumeric and other keys, may be coupled to the bus 1001 for communicating information and command selections to the processor 1003. The input device 1013 can include a cursor control, such as a mouse, a trackball, or cursor direction keys, for communicating direction information and command selections to the processor 1003 and for controlling cursor movement on the display 1011.

According to various embodiments of the invention, the processes described herein can be provided by the computing system 1000 in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 1000 also includes at least one communication interface 1015 coupled to bus 1001. The communication interface 1015 provides a two-way data communication coupling to a network link (not shown). The communication interface 1015 sends and receives electrical, electromagnetic, or optical signals that carry digital data streams representing various types of information. Further, the communication interface 1015 can include peripheral interface devices, such as a Universal Serial Bus (USB) interface, a PCMCIA (Personal Computer Memory Card International Association) interface, etc.

The processor 1003 may execute the transmitted code while being received and/or store the code in the storage device 1009, or other non-volatile storage for later execution. In this manner, the computing system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

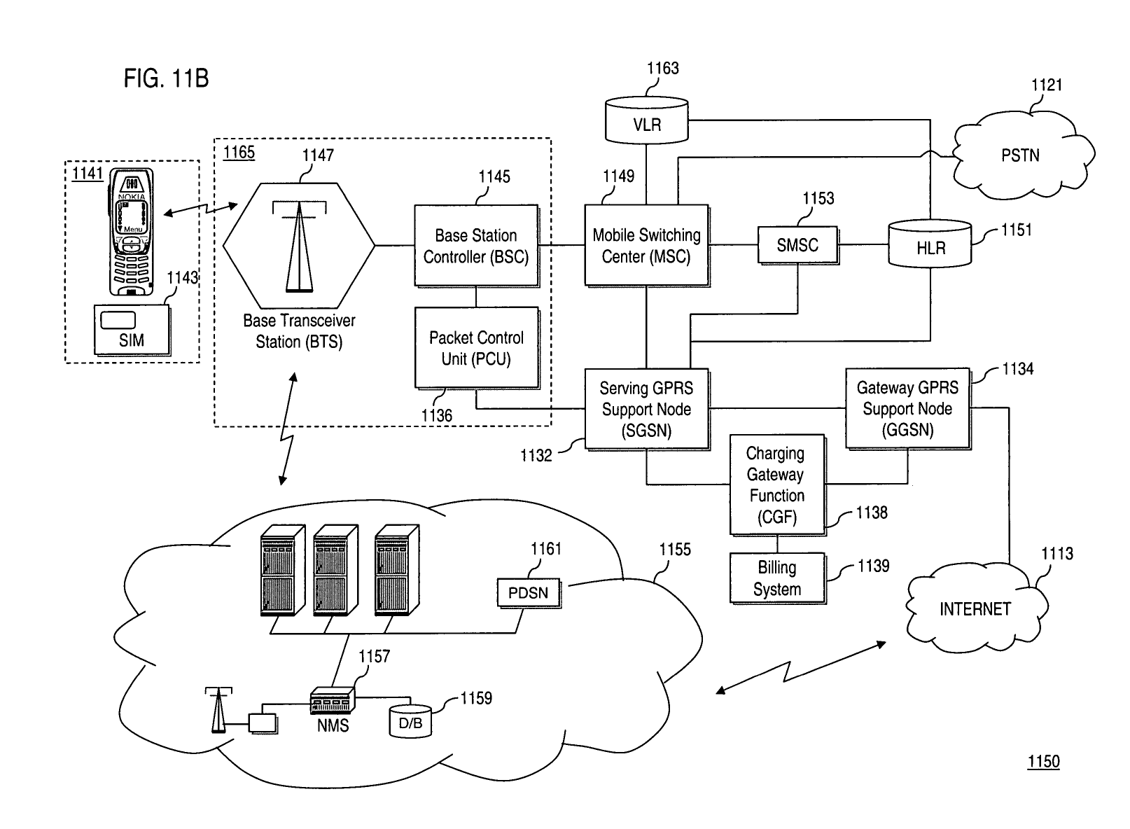

FIGS. 11A and 11 B are diagrams of different cellular mobile phone systems capable of supporting various embodiments of the invention. FIGS. 11A and 11B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 1100 includes mobile stations 1101 (e.g., handsets, terminals, stations, units, devices, or any type of interface to the user (such as “wearable” circuitry, etc.)) in communication with a Base Station Subsystem (BSS) 1103. According to one embodiment of the invention, the radio network supports Third Generation (3G) services as defined by the International Telecommunications Union (ITU) for International Mobile Telecommunications 2000 (IMT-2000).

In this example, the BSS 1103 includes a Base Transceiver Station (BTS) 1105 and Base Station Controller (BSC) 1107. Although a single BTS is shown, it is recognized that multiple BTSs are typically connected to the BSC through, for example, point-to-point links. Each BSS 1103 is linked to a Packet Data Serving Node (PDSN) 1109 through a transmission control entity, or a Packet Control Function (PCF) 1111. Since the PDSN 1109 serves as a gateway to external networks, e.g., the Internet 1113 or other private consumer networks 1115, the PDSN 1109 can include an Access, Authorization and Accounting system (AAA) 1117 to securely determine the identity and privileges of a user and to track each user's activities. The network 1115 comprises a Network Management System (NMS) 1131 linked to one or more databases 1133 that are accessed through a Home Agent (HA) 1135 secured by a Home AAA 1137.

Although a single BSS 1103 is shown, it is recognized that multiple BSSs 1103 are typically connected to a Mobile Switching Center (MSC) 1119. The MSC 1119 provides connectivity to a circuit-switched telephone network, such as the Public Switched Telephone Network (PSTN) 1121. Similarly, it is also recognized that the MSC 1119 may be connected to other MSCs 1119 on the same network 1100 and/or to other radio networks. The MSC 1119 is generally collocated with a Visitor Location Register (VLR) 1123 database that holds temporary information about active subscribers to that MSC 1119. The data within the VLR 1123 database is to a large extent a copy of the Home Location Register (HLR) 1125 database, which stores detailed subscriber service subscription information. In some implementations, the HLR 1125 and VLR 1123 are the same physical database; however, the HLR 1125 can be located at a remote location accessed through, for example, a Signaling System Number 7 (SS7) network. An Authentication Center (AuC) 1127 containing subscriber-specific authentication data, such as a secret authentication key, is associated with the HLR 1125 for authenticating users. Furthermore, the MSC 1119 is connected to a Short Message Service Center (SMSC) 1129 that stores and forwards short messages to and from the radio network 1100.

During typical operation of the cellular telephone system, BTSs 1105 receive and demodulate sets of reverse-link signals from sets of mobile units 1101 conducting telephone calls or other communications. Each reverse-link signal received by a given BTS 1105 is processed within that station. The resulting data is forwarded to the BSC 1107. The BSC 1107 provides call resource allocation and mobility management functionality including the orchestration of soft handoffs between BTSs 1105. The BSC 1107 also routes the received data to the MSC 1119, which in turn provides additional routing and/or switching for interface with the PSTN 1121. The MSC 1119 is also responsible for call setup, call termination, management of inter- MSC handover and supplementary services, and collecting, charging and accounting information. Similarly, the radio network 1100 sends forward-link messages. The PSTN 1121 interfaces with the MSC 1119. The MSC 1119 additionally interfaces with the BSC 1107, which in turn communicates with the BTSs 1105, which modulate and transmit sets of forward-link signals to the sets of mobile units 1101.

As shown in FIG. 11B, the two key elements of the General Packet Radio Service (GPRS) infrastructure 1150 are the Serving GPRS Supporting Node (SGSN) 1132 and the Gateway GPRS Support Node (GGSN) 1134. In addition, the GPRS infrastructure includes a Packet Control Unit PCU 1136 and a Charging Gateway Function (CGF) 1138 linked to a Billing System 1139. A GPRS the Mobile Station (MS) 1141 employs a Subscriber Identity Module (SIM) 1143.

The PCU 1136 is a logical network element responsible for GPRS-related functions such as air interface access control, packet scheduling on the air interface, and packet assembly and re-assembly. Generally the PCU 1136 is physically integrated with the BSC 1145; however, it can be collocated with a BTS 1147 or a SGSN 1132. The SGSN 1132 provides equivalent functions as the MSC 1149 including mobility management, security, and access control functions but in the packet-switched domain. Furthermore, the SGSN 1132 has connectivity with the PCU 1136 through, for example, a Fame Relay-based interface using the BSS GPRS protocol (BSSGP). Although only one SGSN is shown, it is recognized that that multiple SGSNs 1131 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 1145, any given BSC 1145 generally interfaces with one SGSN 1132. Also, the SGSN 1132 is optionally connected with the HLR 1151 through an SS7-based interface using GPRS enhanced Mobile Application Part (MAP) or with the MSC 1149 through an SS7-based interface using Signaling Connection Control Part (SCCP). The SGSN/HLR interface allows the SGSN 1132 to provide location updates to the HLR 1151 and to retrieve GPRS-related subscription information within the SGSN service area. The SGSN/MSC interface enables coordination between circuit-switched services and packet data services such as paging a subscriber for a voice call. Finally, the SGSN 1132 interfaces with a SMSC 1153 to enable short messaging functionality over the network 1150.

The GGSN 1134 is the gateway to external packet data networks, such as the Internet 1113 or other private customer networks 1155. The network 1155 comprises a Network Management System (NMS) 1157 linked to one or more databases 1159 accessed through a PDSN 1161. The GGSN 1134 assigns Internet Protocol (IP) addresses and can also authenticate users acting as a Remote Authentication Dial-In User Service host. Firewalls located at the GGSN 1134 also perform a firewall function to restrict unauthorized traffic. Although only one GGSN 1134 is shown, it is recognized that a given SGSN 1132 may interface with one or more GGSNs 1133 to allow user data to be tunneled between the two entities as well as to and from the network 1150. When external data networks initialize sessions over the GPRS network 1150, the GGSN 1134 queries the HLR 1151 for the SGSN 1132 currently serving a MS 1141.

The BTS 1147 and BSC 1145 manage the radio interface, including controlling which Mobile Station (MS) 1141 has access to the radio channel at what time. These elements essentially relay messages between the MS 1141 and SGSN 1132. The SGSN 1132 manages communications with an MS 1141, sending and receiving data and keeping track of its location. The SGSN 1132 also registers the MS 1141, authenticates the MS 1141, and encrypts data sent to the MS 1141.

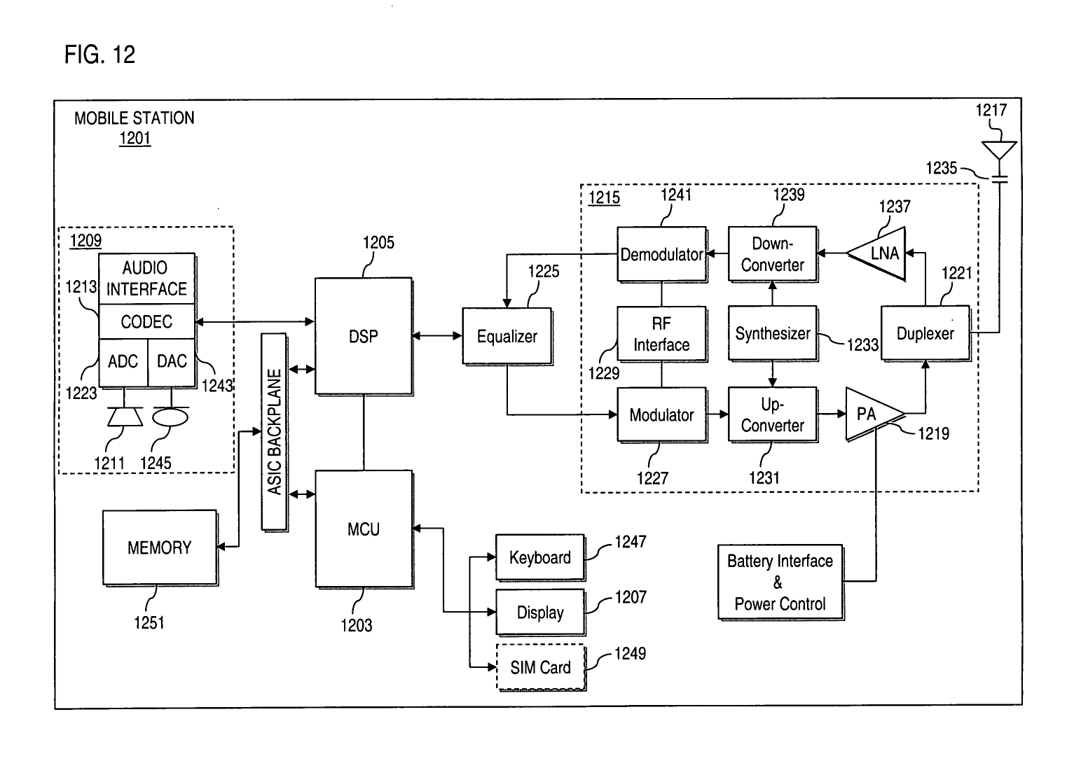

FIG. 12 is a diagram of exemplary components of a mobile station (e.g., handset) capable of operating in the systems of FIGS. 11A and 11B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile station functions. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system (e.g., systems of FIG. 11A or 11B), via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art.

In use, a user of mobile station 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks. Voice signals transmitted to the mobile station 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The MCU 1203 delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the station. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile station 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile station 1201 on a radio network. The card 1249 also contains a memory for storing a personal telephone number registry, text messages, and user specific mobile station settings.

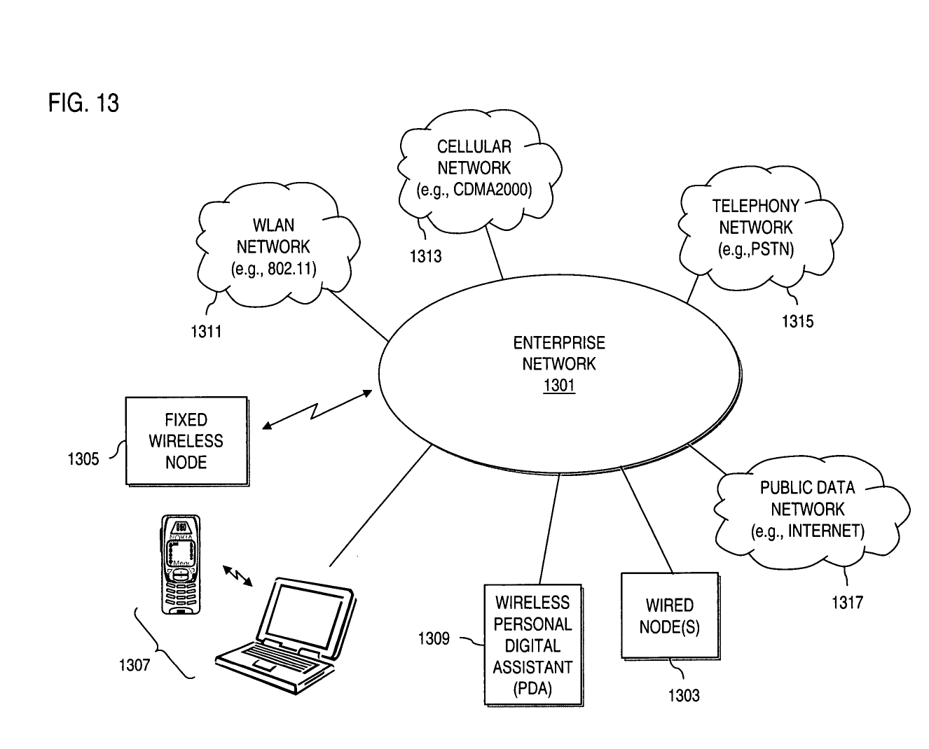

FIG. 13 shows an exemplary enterprise network, which can be any type of data communication network utilizing packet-based and/or cell-based technologies (e.g., Asynchronous Transfer Mode (ATM), Ethernet, IP-based, etc.). The enterprise network 801 provides connectivity for wired nodes 1303 as well as wireless nodes 1305-1309 (fixed or mobile), which are each configured to perform the processes described above. The enterprise network 1301 can communicate with a variety of other networks, such as a WLAN network 1311 (e.g., IEEE 802.11), a cdma2000 cellular network 1313, a telephony network 1315 (e.g., PSTN), or a public data network 1317 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing a request for position location information of a terminal configured to operate with an unlicensed mobile access network that has connectivity with a radio communication network for providing a position location service; and
generating a data message specifying the position location information, wherein the data message and the request are generated according to a signaling protocol that is compatible with the unlicensed mobile access network, reliable delivery of the data message being provided by a transport layer protocol.

2. A method according to claim 1, wherein the unlicensed mobile access network determines whether the request requires establishment of a voice call, and no bearer path is established if the request does not specify the voice call.

3. A method according to claim 2, wherein the bearer path includes a media stream according to a real time protocol (RTP), and the transport layer protocol includes transmission control protocol (TCP), the signaling protocol including unlicensed layer 3 protocol, the reliable delivery of the data message being performed without using acknowledgement signaling by an unlicensed layer 2 protocol.

4. A method according to claim 2, wherein the voice call corresponds to an emergency service call.

5. A method according to claim 1, wherein the request is generated by the terminal.

6. A method according to claim 1, wherein the unlicensed mobile access network includes a position determining entity (PDE) configured to receive the data message and includes a network controller configured to communicate with a mobile switching center within the radio communication network.

7. A method according to claim 1, wherein the unlicensed mobile access network is configured to operate according to an unlicensed mobile access (UMA) architecture and the radio communication network includes a cellular network that is configured to communicate using spread spectrum.

8. An apparatus comprising:
a processor configured to process a request for position location,
wherein the processor is further configured to generate a data message specifying the position location information for transmission over an unlicensed mobile access network that has connectivity with a radio communication network for providing a position location service, the data message and the request being generated according to a signaling protocol that is compatible with the unlicensed mobile access network, reliable delivery of the data message being provided by a transport layer protocol.

9. An apparatus according to claim 8, wherein the unlicensed mobile access network determines whether the request requires establishment of a voice call, and a bearer path is established only if the request specifies the voice call.

10. An apparatus according to claim 9, wherein the bearer path includes a media stream according to a real time protocol (RTP), and the transport layer protocol includes transmission control protocol (TCP), the signaling protocol including unlicensed layer 3 protocol, the reliable delivery of the data message is performed without using acknowledgement signaling by an unlicensed layer 2 protocol.

11. An apparatus according to claim 9, wherein the voice call corresponds to an emergency service call.

12. An apparatus according to claim 8, wherein the request is generated by the terminal.

13. An apparatus according to claim 8, wherein the unlicensed mobile access network includes a position determining entity (PDE) configured to receive the data message and includes a network controller configured to communicate with a mobile switching center within the radio communication network.

14. An apparatus according to claim 8, wherein the unlicensed mobile access network is configured to operate according to an unlicensed mobile access (UMA) architecture and the radio communication network includes a cellular network that is configured to communicate using spread spectrum.

15. A method comprising:
receiving a message to initiate a position location service, the message having a format according to a signaling protocol compatible with an unlicensed mobile access network, wherein the unlicensed mobile access network has connectivity with a radio communication network for providing the position location service;
generating a service request, in response to the received message, for transmission to the radio communication network;
receiving an assignment request from the radio communication network for allocation of network resource within the unlicensed mobile access network; and
generating a data message specifying position location information of a terminal, wherein the data message is generated according to the signaling protocol, and reliable delivery of the data message being provided by a transport layer protocol.

16. A method according to claim 15, further comprising:
determining whether the received message requires establishment of a voice call, and no bearer path is established if the received message does not specify the voice call.

17. A method according to claim 16, wherein the bearer path includes a media stream according to a real time protocol (RTP), and the transport layer protocol includes transmission control protocol (TCP), the signaling protocol including unlicensed layer 3 protocol, the reliable delivery of the data message is performed without using acknowledgement signaling by an unlicensed layer 2 protocol.

18. A method according to claim 16, wherein the voice call corresponds to an emergency service call.

19. A method according to claim 15, wherein the received message is generated by the terminal.

20. A method according to claim 15, wherein the unlicensed mobile access network includes a position determining entity (PDE) configured to provide the position information and a network controller configured to communicate with a mobile switching center within the radio communication network.

21. A method according to claim 15, wherein the unlicensed mobile access network is configured to operate according to an unlicensed mobile access (UMA) architecture and the radio communication network includes a cellular network that is configured to communicate using spread spectrum.

22. An apparatus comprising:
a processor configured to receive a message to initiate a position location service, the message having a format according to a signaling protocol compatible with an unlicensed mobile access network, wherein the unlicensed mobile access network has connectivity with a radio communication network for providing a position location service,
wherein the processor is further configured to generate a service request, in response to the received message, for transmission to the radio communication network, and to receive an assignment request from the radio communication network for allocation of network resource within the unlicensed mobile access network,
wherein the processor is further configured to generate a data message specifying position location information of a terminal, the data message being generated according to the signaling protocol, reliable delivery of the data message being provided by a transport layer protocol.

23. An apparatus according to claim 22, wherein the processor is further configured to determine whether the received message is associated with a voice call, and no bearer path is established if the received message does not specify the voice call.

24. An apparatus according to claim 23, wherein the bearer path includes a media stream according to a real time protocol (RTP), and the transport layer protocol includes transmission control protocol (TCP), the signaling protocol including unlicensed layer 3 protocol, the reliable delivery of the data message being performed without using acknowledgement signaling by an unlicensed layer 2 protocol.

25. An apparatus according to claim 23, wherein the voice call corresponds to an emergency service call.

26. An apparatus according to claim 22, wherein the received message is generated by the terminal.

27. An apparatus according to claim 22, further comprising:
a communication interface configured to provide the position information, wherein the unlicensed mobile access network includes a network controller configured to communicate with a mobile switching center within the radio communication network.

28. An apparatus according to claim 22, wherein the unlicensed mobile access network is configured to operate according to an unlicensed mobile access (UMA) architecture and the radio communication network includes a cellular network that is configured to communicate using spread spectrum.

29. A method comprising:
receiving an origination message according to unlicensed mobile access (UMA) layer 3 protocol to initiate a position location service supported by an unlicensed mobile access network and a cellular communication network;
determining whether the origination message specifies an emergency call;
establishing an audio path to the terminal only if the origination message specifies the emergency call; and
generating a data message specifying the position location information for transmission to a terminal without utilizing an unlicensed mobile access (UMA) layer 2 protocol to acknowledge receipt of the data message, wherein the data message is generated according to the UMA layer 3 protocol.

30. A method according to claim 29, wherein transmission control protocol (TCP) is utilized to provide reliable transmission of the data message to the terminal.

31. A method comprising:
receiving a paging request from a mobile switching center of a cellular network, the paging request initiating a position location service supported by the cellular network and an unlicensed mobile access network; and
generating a data message to obtain position location information of a terminal for transmission to a terminal according to an unlicensed mobile access (UMA) layer 3 protocol, wherein reliable delivery of the data message is provided by a transport layer protocol distinct from a UMA layer 2 protocol.

32. A method according to claim 31, wherein the transport layer protocol includes transmission control protocol (TCP).
